(19) United States
(12) Patent Application Publication
(10) Pub. No.: US 2015/0382085 A1
(43) Pub. Date: Dec. 31, 2015

(54) CONDITION MONITORING DEVICE

(71) Applicants: Thomas LAWRIE-FUSSEY, (US); Matthew LUCAS, (US); Jonathan EDGCOMBE, (US)

(72) Inventors: Thomas Lawrie-Fussey, Cambridge (GB); Matthew Lucas, Cambridge (GB); Jonathan Edgcombe, Cambridge (GB)

(73) Assignee: Cambridge Consultants Limited, Cambridge, Cambridgeshire (GB)

(21) Appl. No.: 14/764,803

(22) PCT Filed: Jan. 31, 2014
(86) PCT No.: PCT/GB2014/050277

§ 371 Date: Jul. 30, 2015

(30) Foreign Application Priority Data
Jan. 31, 2013 (GB) 1301710.8

(51) Int. Cl. H04Q 9/00; G06F 1/32

(52) U.S. Cl. CPC H04Q 9/00; G06F 1/3287

(57) ABSTRACT

A monitoring device for monitoring treatment of the item that includes a sensor for sensing a condition relating to the treatment of the item, a memory arranged to store sensor data, and a communication interface for generating a wireless signal for transmitting the data. The device also includes a detector for detecting a predetermined event relating to the condition. The device is triggered to switch from a low power mode to a high power mode for a finite time period following detection of the predetermined event, and to switch from the high power mode to the low power mode upon expiry of the time period. In the high power mode the device is configured so as to read sensor data at an increased rate in order to gather sensor data or to send a communication signal at an increased rate for establishing a connection for transmitting data.

### CROSS REFERENCE TO RELATED APPLICATIONS

The present application is a National Stage entry under 35 USC 371 and claims priority to PCT/GB2014/050277 filed Jan. 31, 2014 which claims priority to GB1301710.8 filed Jan. 31, 2013.

### BACKGROUND

The present invention relates to a device for attachment to, or embedding within an article. The invention has particular though not exclusive relevance to a device attached to, or embedded within an article such as a letter, parcel, shipment, consignment, package, tote, thermal packaging (active or passive), or other shipping container to monitor its condition. The device may alternatively be in a form suitable for attachment to an article such as: a vehicle windscreen to measure driving parameters such as eco driving and risk; a tool, vehicle, or other apparatus to monitor condition for predictive or non-predictive maintenance; or to a shipment of temperature or shock sensitive healthcare materials including drugs or biologics such as blood or organs to monitor its condition.

There is a need to check whether shipments (e.g. comprising parcels or packages) have been handled safely and appropriately during transport. For example, an article may be damaged if the parcel is dropped or exposed to extremes of temperature or humidity. A customer receiving an article generally is required to perform a brief manual inspection of the article before acknowledging safe receipt. However some types of damage are easily overlooked during such inspection and may not come to light until a later date. Other types of damage, such as deterioration of a substance caused by incorrect storage, may not be ascertainable from inspection. Furthermore, if the article has been damaged, it may be difficult or impossible to ascertain when during the delivery process the article became damaged, which may for example lead to disputes between a customer, and/or various handling entities such as a delivery company or manufacturer.

Mechanical sensors are available for attachment to shipments containing fragile items, for example to indicate whether a parcel has been dropped, or a drug shipment has been held within temperature limits. One such sensor is a vial containing a brightly colored liquid arranged to break if a predetermined load (such as that which would be experienced when the parcel is dropped) is exceeded. However this will not provide an indication of when the event occurred. Data loggers can be used that store data or events, with the data being accessible using a computer for analysis by an expert. However these devices are expensive to buy and complex to use, such that their use is confined to high value items such as instrumentation, and is not suitable for many ordinary consumer items. Additionally, expensive mechanical machines such as industrial drills are designed to last, on average, for a particular number of uses. After this, critical parts such as the drill-bit may fail and need to be replaced. The tool industry finds it difficult to count how many times a tool has been used and hence whether it is likely to fail soon. With better measurement of number of uses and the ability to sense when a tool is heading towards failure, predictive maintenance can be applied, possibly by servicing tools before failure to extend their life, and also spares can be ordered so that time without a working tool is minimized Other systems where many apparatuses of the same type are expected to behave similarly, such as a set of train doors, would also benefit from increased monitoring, looking for ‘out of pattern’ behaviors (either relative to historical data from the same item, or relative to other items of the same type) to enable predictive maintenance or servicing.

Additionally, telematics ‘black box’ units in the automotive industry including both cars and trucks are used to measure driver behavior, for the purposes of accurately pricing risk and preferable insurance premiums, or for measuring whether a driver is ‘eco-driving’ to meet regulations or decrease fuel costs. These currently all require attachment to an OBD port in the car.

### SUMMARY

A monitoring device for mounting to an item in order to monitor the treatment of the item during handling or storage that includes, a sensor for sensing a condition relating to the treatment of the item, a memory arranged to store sensor data, a communication interface arranged to generate a wireless signal for transmitting the data, and a detector for detecting a predetermined event relating to the condition, and the device having a low power mode and a high power mode, the power consumption of the device being relatively higher in the higher power mode, in which the device is triggered to switch from the low power mode to the high power mode for a finite time period following detection of the predetermined event, and to switch from the high power mode upon expiry of the finite time period, and in which the high power mode of the device is configured so as to be operable do at least one of: read sensor data at an increased rate in order to gather sensor data; and send a communication signal at an increased rate for establishing a connection for transmitting data.

### DESCRIPTION OF THE DRAWINGS

In order that the invention may be more readily understood, reference will now be made by way of example to the accompanying drawings, in which:

FIG. 1 is a perspective view of a tag device according to on embodiment of the invention;

FIG. 2 is diagram of a device according to one embodiment of the invention;

FIG. 3 is a diagram of a system for using the device according to the invention; and

FIGS. 4a and 4b are examples of screenshots of a smart phone app for use with the invention as disclosed herein.

### DETAILED DESCRIPTION

The invention as disclosed in the various embodiments aims to provide a relatively inexpensive monitoring apparatus, which when used in conjunction with a smart-device (e.g. smart-phone) provides a simple to use, system that is suitable, for example, for monitoring any of these systems or articles, including parcels, health shipments, automotive measurements, or equipment condition monitoring, and providing information, raw data, data analytics or alerts about how shipments have been handled, automotive data, or equipment condition.

Broadly, the invention as disclosed herein provides a monitoring device for attachment to an item, the device comprising a sensor for sensing a condition relating to the item, and a detector for detecting a predetermined event relating to the condition, the sensor being arranged to gather data concerning the condition for a time period following detection of the event by the detector, a data processor, a memory arranged to store the data, and a communication interface arranged to generate a wireless signal for transmitting the data.

According to one aspect, there is provided a monitoring device for mounting to an item to monitor the treatment of the item during handling or storage, and for being powered by a cell, the device comprising a sensor for sensing a condition relating to the treatment of the item, a memory arranged to store sensor data, and a communication interface arranged to generate a wireless signal for transmitting the data, the device further comprising a detector for detecting a predetermined event relating to the condition, and the device having a low power mode and a high power mode, the power consumption of the device being relatively higher in the high power mode, in which the device is triggered to switch from the low power mode to the high power mode for a finite time period following detection of the predetermined event, and to switch from the high power mode to the low power mode upon expiry of the time period, and in which high power mode the device is configured so as to be operable do at least one of: read sensor data at an increased rate in order to gather sensor data; and send a communication signal at an increased rate for establishing a connection for transmitting data.

In one embodiment, there is provided monitoring device for mounting to an item to monitor the treatment of the item during normal/abnormal operation, and for being powered by a cell, the device comprising a sensor for sensing a condition relating to the treatment or use of the item, a memory arranged to store sensor data, and a communication interface arranged to generate a wireless signal for transmitting the data, the device further comprising a detector for detecting a predetermined event relating to the condition, and the device having a low power mode and a high power mode, the power consumption of the device being relatively higher in the high power mode, in which the device is triggered to switch from the low power mode to the high power mode for a finite time period following detection of the predetermined event, and to switch from the high power mode to the low power mode upon expiry of the time period, and in which high power mode the device is configured so as to be operable to do at least one of: read sensor data at an increased rate in order to gather sensor data; send a communication signal at an increased rate for establishing a connection for transmitting data; select a most relevant power-management algorithm; and/or choose a correct service flow/communication protocol method.

Thus with the device attached to the item such as a parcel or package or an object within the parcel, it may be in a low power or ‘sleep mode’ until a relevant event takes place, such as a threshold value of the condition being exceeded, when the sensor will trigger the device to ‘wake up’ and start buffering data concerning the condition, such as the acceleration experienced during a freefall. The device therefore can be designed to use very little power, such that it may be powered by a single coin cell battery for a long period such as several weeks or months, whilst still capturing data concerning key events with sufficient resolution to be useful for example in accurately detecting peak accelerations.

Alternatively or in addition, the device in the low power mode may send ‘advertising’ signals at a relatively low rate, and may be triggered to increase the rate of the signals upon detection of an event indicating that the device is about to be interrogated, such as the item being moved indicating a delivery event, again enhancing performance while saving power.

The detector may thus be an integral part of the sensor such as an accelerometer, or a temperature or humidity sensor, or orientation sensor such as a gyro or compass. Alternatively the detector function may be implemented via a separate simple or ‘dumb’ sensor coupled to the power management algorithm, which may enhance power saving. The device may comprise one or more further detectors/sensors associated with a plurality of conditions or events.

The communication apparatus preferably uses short range wireless radio technology such as Bluetooth, and is provided with a clock. The communication apparatus may be arranged to operate with a wireless communication technology having a relatively low unimpeded indoor range of up to approximately 50 meters (e.g. between −40 meters and −60 meters), operating in a frequency band of −2.4 to 2.SGHz, and/or having a bit rate of approximately 200 kbit/s (e.g. between 180 kbit/s and 220 kbit/s).The communication apparatus may be arranged to operate with a wireless communication technology having a lower bit rate than conventional Bluetooth. The communication apparatus may be arranged, for example, to operate with a wireless communication technology complying with Bluetooth low energy protocol, in order to save power. Thus the communication ‘advertising event’ can have a pre- configured low periodicity.

The communication apparatus preferably uses a short range, low power wireless radio technology such as Bluetooth Low Energy (BLE), now common in new smart-phones and tablets. The communication apparatus may be arranged to operate with a configurable low-frequency transmit rate, in order to save power. Thus the communication ‘advertising event’ can have a pre-configured low periodicity.

The device may be arranged to monitor the sensor data to infer aspects of the delivery event; for example to determine when a package is being transported in a van, delivered by a person walking etc. so that the advertising frequency may be set and/or adjusted appropriately. The device preferably includes a data processor and a power management component.

Preferably the nature of the data stored in the memory is determined in dependence upon the nature of the sensed event or condition, and the time period for which data is gathered by the sensor is either a predetermined time or may also be dependent upon the nature of the event or condition. Data relating to the time at which the condition or event was sensed is also preferably stored in the memory. For example for an extreme event, the stored data may comprise a simple maximum value and time value, whereas for a less severe event the data may comprise a condition profile over a longer time period.

The invention as described herein may also provide a system including the device, a portable smart device configured for communication with the device, and a remote server configured to communicate with the smart device to obtain the data. Thus a delivery company may interrogate the device remotely via a smart device such as a phone in a delivery van or warehouse. The portable smart device is preferably associated with a GPS device for providing information concerning the location of the device to the system.

The server may, for example, be configured to include features such as digital key management for data confidentiality, authentication of devices and users, and anti-counterfeiting measures. It may also include an analytics engine for processing data. It may also include user interfaces for administration or consultation of data or events. It may also include an alerting mechanism for distributing data, events, or web links to data or events via SMS, email or other messaging systems.

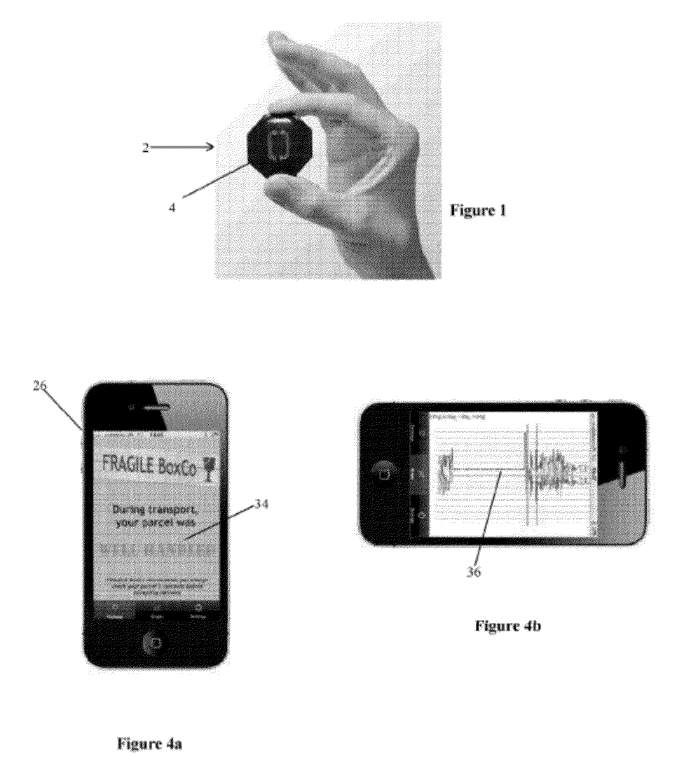

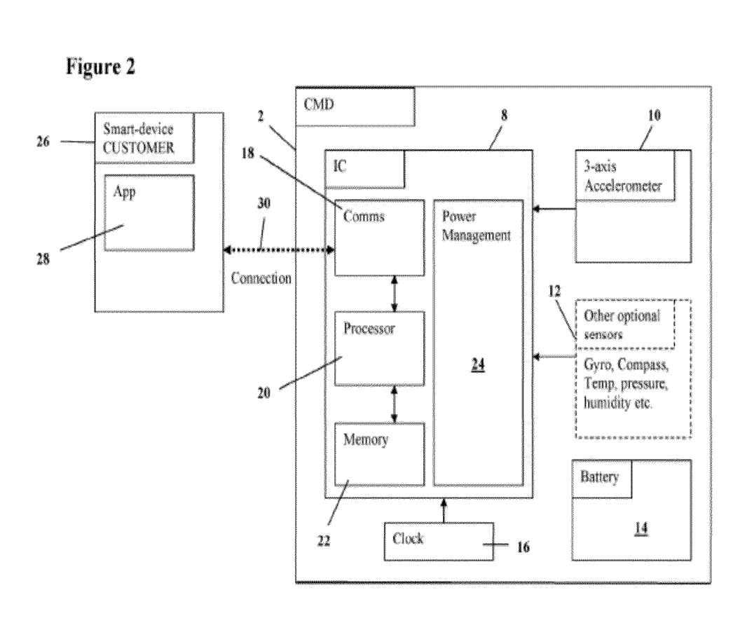

Referring to FIG. 1, a condition monitoring device (CMD) or tag 2 comprises a form factor providing a small housing 4 containing the device components, which are shown schematically in FIG. 2. The housing 4 is small enough such that the CMD may be fitted to a parcel, and may for example be about 40 mm in diameter and 5 mm deep. The device 2 comprises an IC such as a Bluetooth low energy (BLE) chip 8 in communication with a 3-axis accelerometer 10, and optionally one or more additional sensors 12 such as temperature, pressure or humidity sensors. Power is provided by a battery 14 such as a coin cell, and the chip 8 is also provided with a clock 16.

The chip 8 comprises a communication interface 18, coupled to a processor 20, which is coupled to a memory 22, and a power management component 24. The communication interface 18 may use Bluetooth, Bluetooth low energy, NFC, WiFi, 3G/2G, LTE, Zigbee or any other suitable wireless protocol. The interface 18 is configured to send an ‘advertise’ signal periodically which can be detected by a corresponding device of for example a customer's smart phone 26 or other smart device, and is configured to establish a connection 30 with the smart phone 26 for the transfer of data. Conveniently, the system of the invention also provides a smart phone application (app) 28 which can be installed on the smart phone 26 for use interrogating the tag 2. As an example, BLE devices typically have a range of about 50 m indoors (if the transmit route is unimpeded).

The communication interface 18 may be configured to have a low periodicity that is a compromise between the transmission frequency and acceptable retrieval probability on a corresponding smart device, in order to conserve battery life. The interface 18 may be provided with dynamic optimization of the ‘advertising event’ periodicity whilst still using COTS smart devices, in order to transmit the advertising event at a higher rate when a typical delivery event is detected. Thus the processor may use the profile of the data from the sensor(s), for example from the accelerometer, to infer whether the parcel is being transported in a van or being carried, and adjust the periodicity accordingly. For example if the parcel is being carried after a period of being in a van then the periodicity may be increased to better enable swift communication with a smart device, since it is likely that a customer will want to interrogate the tag 2 at that time.

There are of course many other circumstances of combinations of circumstance which can be inferred from processing of the sensor data which may indicate that the tag is about to the interrogated and the periodicity should be increased, or vice versa. As another example, the device may be configured such that by tapping on the box or shaking it gently at a predetermined frequency (chosen to be different to those frequencies usually seen in transit due to road vibrations etc.) the device could be ‘woken’ from its sleep mode immediately. Thus if the item needs to be interrogated and the sensors haven't detected a typical delivery event, the package can be gently tapped/shaken to ‘wake’ the device thus causing it to transmit in high-rate mode.

The accelerometer 10 serves as an event sensor configured to trigger its interrupt command and to start buffering for example at the onset of freefall detection. For example, the command may be triggered if the acceleration detected exceeds a predetermined threshold level which is distinct from normal background levels indicating normal or acceptable handling of the parcel. Therefore the higher fidelity ‘log’ mode may be activated only when needed. The data is sent to the chip 8, which reads the data during an event window, until the event such as a drop event is complete. This may be a predetermined time frame or may be determined in dependence upon the data. For example the chip may collect the data at about 400 Hz for 1 second or more, although it may block read the data faster than it collects it.

The device may be configured using a platform design approach such that additional sensors 12 can be added. A low power mode for any sensors or a sensor cluster may be implemented as a default outside of an event window. This can be done within a sub-system of the sensor(s) or may be controlled by a function of the power management component coded on the chip 8. Thus aspects of the power management algorithm may be implemented on the chip 8, such as the smart sensing function described above, wherein power consumption is minimized when the sensor is in ‘sleep’ mode, and the communication low-power/low-frequency advertise mode also described above when it is inferred that the device is not near an interrogating smart device. When the device comes out of ‘sleep’ mode in response to an event, an event relevant power-management algorithm may be selected, and/or an appropriate service flow/communication protocol may be selected, in dependence on the nature of the detected event.

The memory 22 stores the processed sensor data relating to critical events, ready for transmission to a smart device, such as to a smart phone app. How data is stored may be dependent upon the nature of the event sensed. For example, for a severe drop event (one where a predetermined acceleration is exceeded), only the maximum value of the acceleration, the height of the drop, and the time of the drop need be stored. For a less violent event, more data may be stored since more data is needed to provide useful information about the nature of the event and to determine the severity of the event and therefore advise whether or not the parcel has been correctly or well handled.

Upon delivery, a customer can interrogate the tag 2, for example by starting a dedicated app, in order to verify the condition of the parcel before signing for it. The app displays critical events (if any) which have occurred during transit. Referring to FIGS. 4a and 4b, the app may for example provide a page with a summary 34 of the package condition (FIG. 4a) and a page with a detailed time/severity log plot 36 (FIG. 4b), enabling the customer to make an informed decision whether or not to accept the parcel as undamaged. Furthermore if the parcel should not be accepted, the app shows exactly what happened to the parcel and when, and hence prevents the usual ambiguity when there is a complex logistics chain.

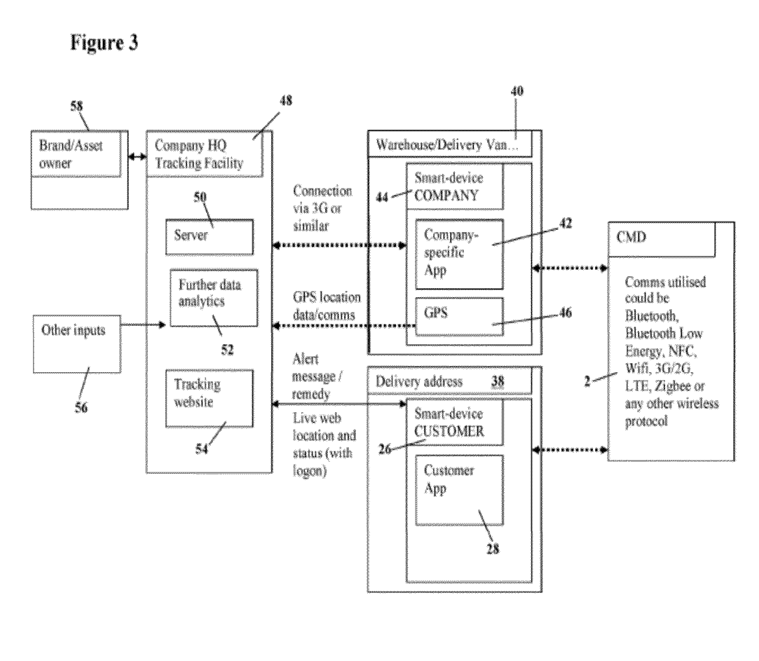

In use, the tag 2 can be inserted within a package to avoid tampering issues and ensure the data relates to the content of the package and not the packaging itself. Alternatively the tag 2 could be included within the construction of a fragile object for example a smart television. Referring to FIG. 3, as already discussed a customer interrogate the tag 2 via an app 28 installed on a smart device 26 such as a phone at a delivery address 38.

In addition the system may include a tracking facility associated with a ‘headquarters’ 48 of a company having an interest in the transport of the package, such as a delivery company. The tracking facility may provide a server 50 such as a cloud server, which could for example allow remote monitoring of data relating to the package through a company smart device 44 located in a delivery van or at a warehouse 40, preferably being GPS enabled, interrogating the tag 2. The location of the package may be derived from a GPS device 46 associated with the smart device 44 if the smart device is in the interrogation range of the tag 2 (maximum range is 50 m indoors for BLE). The tag 2 may thus be interrogated at any stage of the logistics delivery process by use of a company-specific app 42 on the smart device 44.

The tracking facility 48 may be provided with further data processing equipment 52 for processing the date remotely. Such data processing can use more powerful algorithms since processing power and power consumption will not be limited as for a portable device. Furthermore other sources of data 56 may be used to supplement the data from the CMD. Location and condition data retrieved in this way could remove the need to physically inspect and handle packages, increasing the speed and efficiency of logistics processing for example by replacing the need to scan barcodes in warehouses etc. Other interested parties 58 such as manufacturers, brand owners, or asset owners may also be able to access data via the tracking facility 48.

Furthermore the company can react to sensed incidents pro-actively, for example reordering an item, sending a message or alert informing a customer of potential damage, etc. In addition the facility may provide a website 54 for use by customers to track the condition and location of a package, which could potentially be independent of any specific carrier. In the case where the tag 2 is incorporated into the item by the manufacturer, the manufacturer may also be able to remotely connect with the tag 2 to check it's condition, thereby enabling the manufacturer to assess warranty claims during delivery, installation and subsequent use.

It will be appreciated that whilst the above description is primarily concerned with an embodiment in which a device is configured for attachment to an article such as a letter, parcel, shipment, consignment, package, thermal packaging (active or passive), or other shipping container to monitor its condition, the invention has much wider applicability. It is envisaged, for example, that a tag according to the invention may also have uses outside the field of parcel delivery.

In more detail, examples of other potential applications include:
(a) Cold chain pharmaceuticals. The delivery of many drugs is temperature dependent—i.e. if the temperature of a container is allowed to drift above a certain value, the drugs then become inactive, even though there is no visible indication of this. The device of the invention could provide a ‘real-time’ temperature (or other condition) alert during transit, or a smartphone could be used to check condition before delivery to a healthcare professional, or even by an end user such as a healthcare professional or patient (e.g. a “don't administer” warning could be provided if the drugs have been subject to certain temperature or other events). In such an embodiment, for example, the monitoring device may be configured for attaching to a medical shipment sensitive to temperature or shock such as a drug shipment, vaccine shipment, organ, or other biologic or non-biologic shipment. An event such as temperature exceeding or falling below a predetermined threshold for a particular drug or the like, or a shock event, or cumulative shock over time, exceeding a predetermined threshold, may trigger data acquisition and/or an associated alert
(b) Vehicle usage monitoring. The device could enable vehicle driving styles to be assessed and relayed via smartphone. This could for example be part of a variable insurance policy based on use. In such an embodiment, for example, the device may be configured for attachment to a vehicle windscreen (or ‘windshield’) to measure, via the vibrations induced to the windscreen during vehicle use, driving parameters such as driving economy and risk. Such a device may include sensors such as accelerometers to monitor driving behavior including g-forces and also vibrational characteristics relating to engine revolutions per minute (RPM), wheel RPM or other automotive data, enabling estimation of engine conditions, and also enabling estimation of current engaged gear, whether by predetermined threshold limits according to a training data set, or algorithmic ‘learning’ of which gears are likely to be in use according to historical and current data. Such a device may be powered by a cell, or a solar panel, or a combination of solar panel and cell (e.g. as a backup).
(c) The device could also be used to provide an aftermarket eCall functionality. It is anticipated that new vehicles may be required to have a facility to call the emergency services in a severe crash (for example one where airbags have been deployed). The device could provide similar crash data to a smartphone and hence enable older cars to be retrofitted with similar functionality.
(d) V2V, or Vehicle to Vehicle communications. The device could be used as an aftermarket add-on to allow cars to communicate with each other—i.e. if one sensor detects a skid event, it can share a warning of icy road conditions via the network of similarly enabled tags to other nearby cars (including those going in the opposite direction). V2V is a system being developed in the automotive sector by the major OEMs, but widespread adoption may well be limited if only available on new luxury cars. The device would be a low-cost (but less capable) alternative to facilitate the growth and acceptance of the V2V device market.
(e) Train integrity/positioning. There is a need for train operators to know if all train carriages remain connected. Current signally relies on detecting the rear lamp on the end carriage before opening up a zone of track. If the device is made to be robust, the range limit of around 50 m could be advantageous, whereby an ad hoc mesh of devices could be formed, with a device affixed to each carriage. If the carriages did part, the network would be broken, and an alert raised. Such a system could also provide a more accurate representation of the total length of the train, based on how many devices are visible.
(f) Equipment monitoring. The device could be used to provide monitoring for equipment such as power tools, manufacturing equipment, and the like. For example, the monitoring device may be configured for attaching to a piece of equipment intended to be used many times such as pneumatic drill, or a train door, or an impact tool, or an elevator, or a building door. The device may, for example, monitor for fault conditions, out of pattern behaviors: by comparison against a ‘normal’ profile where the ‘normal’ profile may be represented by predefined thresholds; by comparison against other equipment of the same type or installed in a similar environment; or by comparison against historical performance of the equipment being monitored.
(g) Building efficiency monitoring. In another example, the device may be configured for attaching to a door or other entrance to a room or a building, for the purposes of establishing whether the building is being used efficiently. The device may, for example, detect ‘door opening’ and/or ‘door closing’ events via an accelerometer for use in determining whether energy efficient use is being made of the building. Similarly, a device could be configured for sensing temperature changes in a room for use in heat management decisions (there could be more than one sensor in a room).

Optionally the device may include one or more security components, for the purposes of verifying messages from other systems such a smartphone or server, or confirming the authenticity of the device to other systems such as a smartphone or server. Digital keys used by this security component(s) may include symmetric keys for short range radio links to another radio-enabled device (for instance a Bluetooth link key), symmetric keys for links with multiple hops such as via a smartphone to a server, or public/private key pairs with associated algorithms such as ECDSA or ECDH for applying digital signatures to data generated by the device, verifying signatures applied by an external system such as a server generated firmware upgrade or control message, or for key exchange or key transport to set up efficient session keys for block or chained encrypted sessions, using algorithms such as AES. An off the shelf discrete security chip such as the Atmel ECC 108 or Infineon Optiga may act as a secure container for these digital keys, including tamper resistance and RF/timing attack resistant features. The device may be embedded within a material as part of a manufacturing process, such that the manufacturing and assembly processes can be optimized, thus potentially leaving the redundant device within material post-manufacture.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A monitoring device for mounting to an item to monitor the treatment of the item during handling or storage, and for being powered by a cell, the device comprising a sensor for sensing a condition relating to the treatment of the item, a memory arranged to store sensor data, a communication interface arranged to generate a wireless signal for transmitting the data, and a detector for detecting a predetermined event relating to the condition, and the device having a low power mode and a high power mode, the power consumption of the device being relatively higher in the higher power mode, in which the device is triggered to switch from the low power mode to the high power mode for a finite time period following detection of the predetermined event, and to switch from the high power mode upon expiry of the finite time period, and in which the high power mode of the device is configured so as to be operable do at least one of:
read sensor data at an increased rate in order to gather sensor data; and
send a communication signal at an increased rate for establishing a connection for transmitting data.

2. The device as claimed in claim 1, in which the high power mode the device is configured to read the sensor data and to vary the rate of sending the communication signal in dependence upon the sensor data.

3. The device as claimed in claim 1, in which the predetermined event is a threshold value of the condition.

4. The device as claimed in claim 1, in which the time period is a predetermined time period, or in which the device is configured to vary the time period in dependence upon the data.

5. The device as claimed in claim 1, in which the detector is an integral part of the sensor.

6. The device as claimed in claim 1, in which the sensor is one of the following, an accelerometer, a temperature or humidity sensor, or an orientation sensor such as a gyro or compass.

7. The device as claimed in claim 1, comprising at least one additional, sensor wherein at least one additional sensor is associated with a further condition.

8. The device as claimed in claim 1, in which the communication interface is provided with a clock and is configured to communicate using short-range wireless radio technology.

9. The device as claimed in claim 8, in which the communication interface is configured to communicate using short-range wireless radio technology having an unimpeded indoor range of up to approximately 50 meters, operating in a frequency band of ˜2.4 to 2.5 GHz, and/or having a bit rate between 180 kbit/s and 220 kbit/s.

10. The device as claimed in claim 8, further comprising a data processor arranged to provide a profile of data from the sensor, and a power management component configured to vary the duty cycle in dependence upon the profile of data.

11. The device as claimed in claim 10, in which the data processor determines, in dependence upon the nature of the sensed event or condition, at least one of: the nature of the data stored in the memory; a choice of the service flow/communications.

12. The device as claimed in claim 1, in which the data includes data relating to the time at which the condition or event was sensed.

13. The device as claimed in claim 1, wherein the device is configured for attachment to, or embedding within an item comprising a package or packaged item wherein the condition is a condition relating to the way in which the package or packaged item is handled during transit.

14. The device as claimed in 1, wherein the device is configured for attachment to, or embedding within an item comprising part of a vehicle and wherein the condition is a condition relating to at least one of the following: the way each vehicle is driven; the way an engine of the vehicle is performing; the way a vehicle component is performing.

15. The device as claimed in claim 14, wherein the sensor is configured for sensing at least one of the following: a condition associated with vibrations arising from the way in which the vehicle is driven; a condition associated with vibrations from the way an engine of the vehicle is performing; a condition associated with vibrations arising from the way a vehicle component is performing.

16. The device as claimed in claim 15, wherein the sensor is configured for sensing the condition associated with the vibrations via a windscreen of the vehicle.

17. The device as claimed claim 1, wherein the device is configured for attachment to, or embedding within an item comprising part of a powered equipment tool and wherein the condition is one of the following: a condition relating to the way in which the equipment is used; a condition relating to the way in which a component of the tool is performing; wherein the device is configured to provide active control of the powered equipment tool based on said condition.

18. The device as claimed in claim 17 wherein the sensor is configured for sensing a condition associated with the use of the powered equipment tool, and wherein the condition is at least one of the following: the number of times the tool is used, the cumulative time that the tool is used; the vibration detected; impacts detected; energy detected; movement detected; heat-permeation detected.

19. The device as claimed in claim 17 wherein the sensor is configured for sensing a condition associated with the manner in which the tool is used.

20. The device as claimed in any of claims 1, wherein the device is configured for attachment to, or embedding within an item holding a temperature sensitive material or substance and wherein the condition is a condition relating to the temperatures to which the temperature sensitive material is exposed during transit or storage.

21. The device as claimed in claim 1, wherein the device is embedded within a material of the item as part of a manufacturing process.

22. The device as claimed in claim 1, wherein said condition is a condition relating to treatment of the item during normal/abnormal operation of the item or apparatus that the item forms part of.

23. The system including a device as claimed in claim 1, a portable smart device configured for communication with the device, and a remote server configured to communicate with the smart device to obtain the data.

24. The system as claimed in claim 23, in which the portable smart device is associated with a GPS device for providing information concerning the location of the device to the server.

25. A method of monitoring, using apparatus powered by a cell, the treatment of an item during handling or storage, the method comprising: sensing a condition relating to the treatment of the item; storing data arising from said sensing; detecting a predetermined event relating to the condition; switching from a low power mode to a high power mode for a finite time period following detection of the predetermined event, the power consumption of the apparatus being relatively higher in the high power mode compared to the low power mode; in the high power mode doing at least one of reading sensor data at an increased rate compared to the low power mode in order to gather sensor data, and sending a communication signal at an increased rate compared to the low power mode for establishing a connection for transmitting data; and switching from the high power mode to the low power mode upon expiry of the time period.
